(19) United States
(12) Patent Application Publication
(10) Pub. No.: US 2016/0204695 A1
(43) Pub. Date: Jul. 14, 2016

(54) CHARGE PUMP CIRCUIT AND METHOD OF CONTROLLING SAME

(71) Applicant: Macronix International Co., Ltd., Hsinchu (TW)

(72) Inventors: Wu-Chin PENG, Hsinchu City (TW); Hsing-Yu LIU, Hsinchu City (TW); Chun-Yi LEE, Hsinchu City (TW); Ken-Hui CHEN, Hsinchu City (TW); Kuen-Long CHANG, Taipei City (TW); Chun Hsiung HUNG, Hsinchu City (TW)

(73) Assignee: Macronix International Co., Ltd.

(21) Appl. No.: 14/737,788

(22) Filed: Jun. 12, 2015

Related U.S. Application Data
(60) Provisional application No. 62/103,275, filed on Jan. 14, 2015.

(51) Int. Cl. H02M 3/07

(52) U.S. Cl. CPC H02M 3/07

(57) ABSTRACT

A charge pump circuit includes a plurality of branches coupled in parallel, each branch including a plurality of sub-blocks coupled in series, and each sub-block including a unit pump circuit. The charge pump circuit also includes a plurality of clock transfer circuits coupled to corresponding ones of the plurality of branches for providing clock signals to the corresponding branches. The sub-blocks of different branches are enabled and driven by the clock signals at different times.

### CROSS-REFERENCE TO RELATED APPLICATION

This application claims benefit of U.S. Provisional Application No. 62/103,275, filed on Jan. 14, 2015, the disclosure of which is incorporated herein by reference in its entirety.

### FIELD OF THE DISCLOSURE

The present disclosure relates to a charge pump circuit and, more particularly, to a charge pump circuit with reduced current and method of controlling the same.

### BACKGROUND

Charge pump circuits have been widely used in various circuits for providing voltages exceeding a power supply voltage. A conventional charge pump circuit includes multiple capacitors that are repeatedly charged and discharged to “pump” the output voltage of the charge pump circuit. However, the conventional charge pump circuit has a disadvantage of high power consumption due to the charging and discharging of the capacitors.

### SUMMARY

According to an embodiment of the disclosure, a charge pump circuit includes a plurality of branches coupled in parallel, each branch including a plurality of sub-blocks coupled in series, and each sub-block including a unit pump circuit. The charge pump circuit also includes a plurality of clock transfer circuits coupled to corresponding ones of the plurality of branches for providing clock signals to the corresponding branches. The sub-blocks of different branches are enabled and driven by the clock signals at different times.

According to another embodiment of the disclosure, a charge pump circuit includes a plurality of branches coupled in parallel, each branch including a plurality of sub-blocks coupled in series, and each sub-block including a unit pump circuit and a delay circuit. The charge pump circuit also includes a plurality of clock transfer circuits coupled to corresponding ones of the plurality of branches for providing clock signals to the corresponding branches. The sub-blocks of each branch are sequentially enabled and driven by the clock signals.

According to still another embodiment of the disclosure, a method for controlling a charge pump circuit includes providing the charge pump circuit including a plurality of branches coupled in parallel, each branch including a plurality of sub-blocks coupled in series, and enabling and driving the sub-blocks of different branches at different times.

According to a further embodiment of the disclosure, a method for controlling a charge pump circuit includes providing the charge pump circuit including a plurality of branches coupled in parallel, each branch including a plurality of sub-blocks coupled in series, and sequentially enabling and driving the sub-blocks of each branch.

The accompanying drawings, which are incorporated in and constitute a part of this application, illustrate disclosed embodiments and, together with the description, serve to explain the disclosed embodiments.

### BRIEF DESCRIPTION OF THE DRAWINGS

FIG. 1 schematically illustrates a charge pump circuit, according to an illustrated embodiment.

FIG. 2 schematically illustrates a circuit diagram of a unit pump circuit, according to an illustrated embodiment.

FIG. 3 schematically illustrates waveforms of signals for controlling the charge pump circuit of FIG. 1, according to an illustrated embodiment.

FIG. 4 schematically illustrates a charge pump circuit, according to an illustrated embodiment.

FIG. 5 schematically illustrates a circuit for generating clock signals shown in FIG. 4, according to an illustrated embodiment.

FIG. 6 schematically illustrates waveforms of signals for controlling the charge pump circuit of FIG. 4, according to an illustrated embodiment.

FIG. 7 schematically illustrates a charge pump circuit, according to an illustrated embodiment.

FIG. 8 schematically illustrates waveforms of signals for controlling the charge pump circuit of FIG. 7, according to an illustrated embodiment.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

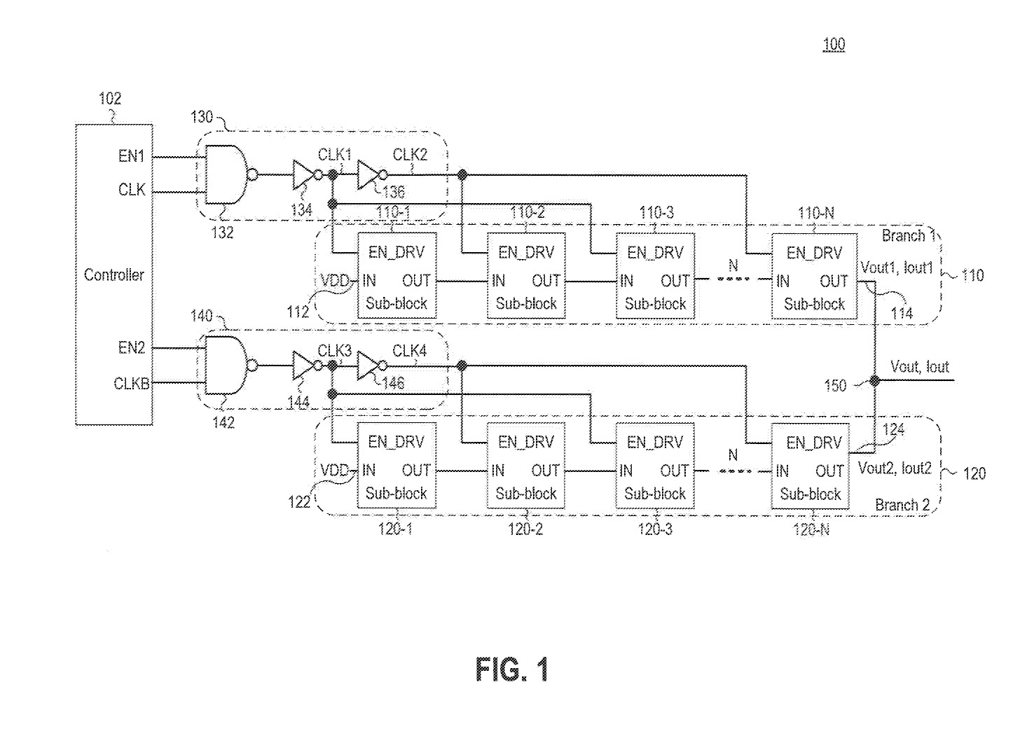

FIG. 1 schematically illustrates a charge pump circuit 100 (hereinafter referred to as “circuit 100”), according to an illustrated embodiment. Circuit 100 includes a first branch 110, a second branch 120 coupled in parallel with first branch 110, a first clock transfer circuit 130 coupled to first branch 110, and a second clock transfer circuit 140 coupled to second branch 120.

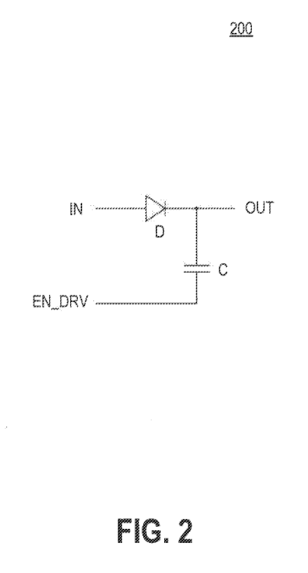

First branch 110 includes an input end 112 for receiving a first supply voltage VDD, an output end 114 for outputting a first output voltage Vout1 and a first output current Iout1, and N sub-blocks 110-1, 110-2, . . . , 110-N coupled in series between input end 112 and output end 114, where N is an even number. Sub-blocks 110-1, 110-2, . . . , 110-N have the same structure. Each one of sub-blocks 110-1, 110-2, . . . , 110-N includes a unit pump circuit, which will be described in detail with reference to FIG. 2. Each one of sub-blocks 110-1, 110-2, . . . , 110-N includes a driver enable terminal EN_DRV, an input terminal IN, and an output terminal OUT. Input terminal IN of the first sub-block 110-1 constitutes input end 112 of first branch 110, and is coupled to receive the first supply voltage VDD. Output terminal OUT of each of sub-blocks 110-1, 110-2, . . . , 110-N−1 is coupled to the input terminal IN of the next sub-block. Output terminal OUT of the last sub-block 110-N constitutes output end 114 of first branch 110, and is coupled to output the first output voltage Vout1 and the first output current Iout1 to an external load (not illustrated). Driver enable terminals EN_DRV of sub-blocks 110-1, 110-2, . . . , 110-N are coupled to first clock transfer circuit 130 to receive clock signals.

First clock transfer circuit 130 includes a first NAND gate 132, a first inverter 134, and a second inverter 136 coupled in series. First clock transfer circuit 130 receives a first enable signal EN1 and a clock signal CLK from a controller 102, and generates and selectively applies a first clock signal CLK1 and a second clock signal CLK2 to sub-blocks 110-1, 110-2, . . . , 110-N of first branch 110. Specifically, first NAND gate 132 includes a first input terminal coupled to receive first enable signal EN1, a second input terminal coupled to receive clock signal CLK, and an output terminal coupled to an input terminal of first inverter 134. First inverter 134 includes the input terminal coupled to the output terminal of first NAND gate 132, and an output terminal coupled to an input terminal of second inverter 136 and the driver enable terminals EN_DRV of odd-numbered sub-blocks 110-1, 110-3, . . . , 110-N−1 to provide first clock signal CLK1. Second inverter 136 includes the input terminal coupled to the output terminal of first inverter 134, and an output terminal coupled to the driver enable terminals EN_DRV of even-numbered sub-blocks 110-2, 110-4, . . . , 110-N, to provide second clock signal CLK2.

Clock signal CLK alternates between the first supply voltage VDD and a second supply voltage Vss (e.g., ground). When the first enable signal EN1 is at a high level, first clock signal CLK1 output from first inverter 134 has the same phase and amplitude as clock signal CLK, and second clock signal CLK2 output from second inverter 136 is an inversion of clock signal CLK.

The structure of second branch 120 is similar to that of first branch 110. Specifically, second branch 120 includes an input end 122 for receiving the first supply voltage VDD, an output end 124 for outputting an output voltage Vout2 and a second output current Iout2, and N sub-blocks 120-1, 120-2, . . . , 120-N coupled in series between input end 122 and output end 124. Sub-blocks 120-1, 120-2, . . . , 120-N have the same structure. Each of first branch 110 and second branch 120 has the same number (N) of sub-blocks. Each one of sub-blocks 120-1, 120-2, . . . , 120-N includes a unit pump circuit, which will be described in detail with reference to FIG. 2. Each one of sub-blocks 120-1, 120-2, . . . , 120-N includes a driver enable terminal EN_DRV, an input terminal IN, and an output terminal OUT. Input terminal IN of the first sub-block 120-1 constitutes input end 122 of second branch 120, and is coupled to receive the first supply voltage VDD. Output terminal OUT of each of sub-blocks 120-1, 120-2, . . . , 120-N−1 is coupled to input terminal IN of the next sub-block. Output terminal OUT of the last sub-block 120-N constitutes output end 124 of second branch 120, and is coupled to output the second output voltage Vout2 and the second output current Iout2 to the external load. Driver enable terminals EN_DRV of sub-blocks 120-1, 120-2, . . . , 120-N are coupled to second clock transfer circuit 140 to receive clock signals.

Output ends 114 and 124 of first and second branches 110 and 120 are respectively coupled to an output node 150 of circuit 100. Because first and second branches 110 and 120 include the same number of sub-blocks, Vout1 and Vout2 have the same magnitude. Thus, circuit 100 provides an output voltage Vout which has the same magnitude as Vout1 and Vout2, and an output current Iout which is the sum of Iout1 and Iout2.

Second clock transfer circuit 140 includes a second NAND gate 142, a third inverter 144, and a fourth inverter 146 coupled in series. Second clock transfer circuit 140 receives a second enable signal EN2 and an inverted clock signal CLKB from controller 102, and generates and selectively applies a third clock signal CLK3 and a fourth clock signal CLK4 to sub-blocks 120-1, 120-2, . . . , 120-N of second branch 120. Inverted clock signal CLKB is an inversion of clock signal CLK. Specifically, second NAND gate 142 includes a first input terminal coupled to receive second enable signal EN2, a second input terminal coupled to receive inverted clock signal CLKB, and an output terminal coupled to an input terminal of third inverter 144. Third inverter 144 includes the input terminal coupled to the output terminal of second NAND gate 142, and an output terminal coupled to an input terminal of fourth inverter 146 and the driver enable terminals EN_DRV of odd-numbered sub-blocks 120-1, 120-3, . . . , 120-N−1, to provide third clock signal CLK3. Fourth inverter 146 includes the input terminal coupled to the output terminal of third inverter 144, and an output terminal coupled to the driver enable terminals EN_DRV of even-numbered sub-blocks 120-2, 120-4, . . . , 120-N, to provide fourth clock signal CLK4.

When the second enable signal EN2 is at the high level, third clock signal CLK3 output from third inverter 144 is the same as clock signal CLKB, and fourth clock signal CLK4 output from fourth inverter 146 is an inversion of the clock signal CLKB.

FIG. 2 schematically illustrates a circuit diagram of a unit pump circuit 200, as an exemplary structure of sub-blocks 110-1, 110-2, . . . , 110-N, 120-1, 120-2, . . . , 120-N of circuit 100. Unit pump circuit 200 includes a driver enable terminal EN_DRV, an input terminal IN, an output terminal OUT, a diode D, and a capacitor C. Diode D includes a first terminal coupled to input terminal IN, and a second terminal coupled to output terminal OUT. Capacitor C includes a first terminal coupled to driver enable terminal EN_DRV, and a second terminal coupled to output terminal OUT.

During the operation of unit pump circuit 200, when a clock signal applied at driver enable terminal EN_DRV is at a low level (e.g., ground), the voltage (e.g., VDD) at input terminal IN is applied to capacitor C to charge capacitor C to a voltage of VDD-Vt, where Vt is the threshold voltage of diode D. When the clock signal applied at driver enable terminal EN_DRV is at a high level (e.g., VDD), the voltage at output terminal OUT increases to 2 VDD-Vt.

Unit pump circuit 200 illustrated in FIG. 2 is an example of the sub-blocks of circuit 100. However, the present disclosure is not so limited. The sub-blocks of circuit 100 can include other unit pump circuits, including unit pumps circuits known in the art.

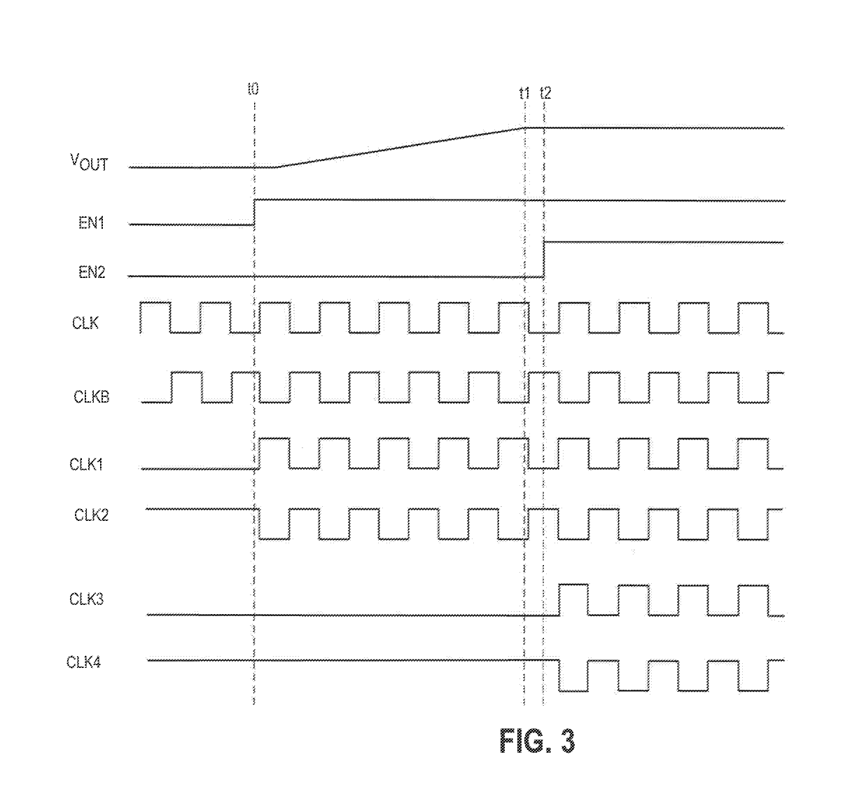

FIG. 3 schematically illustrates waveforms of signals for controlling circuit 100 of FIG. 1, according to an illustrated embodiment. The waveform of Vout at output node 150 of circuit 100 is also illustrated.

Before time t0, both first enable signal EN1 and second enable signal EN2 are at a low level (e.g., ground). As a result, the first and third clock signals CLK1 and CLK3 do not alternate and remain as the second supply voltage Vss (e.g., ground). Similarly, the second and fourth clock signals CLK2 and CLK4 do not alternate and remain as the first supply voltage VDD. Thus, no alternating clock signal is applied to sub-blocks 110-1, 110-2, . . . , 110-N of first branch 110 and sub-blocks 120-1, 120-2, . . . , 120-N of second branch 120. Consequently, neither one of first branch 110 and second branch 120 is enabled, and thus output voltage Vout at output node 150 of circuit 100 is at a low level (e.g., 0V).

At time t0, first enable signal EN1 transitions from the low level to a high level. In response to first enable signal EN1 being at the high level, first and second clock signals CLK1 and CLK2 start alternating between VDD and ground. As a result, sub-blocks 110-1, 110-2, . . . , 110-N of first branch 110 are enabled and driven by first enable signal EN1 and clock signal CLK, and thus a pumping process of first branch 110 starts. Specifically, the odd-numbered sub-blocks 110-1, 110-3, . . . , and even-numbered sub-blocks 110-2, 110-4, . . . , are respectively driven by first clock signal CLK1 and second clock signal CLK2 in alternate time intervals. Therefore, each sub-block is charged by the charge in its previous sub-block. As a result, first output voltage Vout1 at output end 114 of first branch 110 and output voltage Vout at output node 150 of circuit 100 are pumped until they reach N×VDD at time t1, where N is the number of sub-blocks in first branch 110.

At time t2, second enable signal EN2 transitions from the low level to the high level. In response to second enable signal EN2 being at the high level, third and fourth clock signals CLK3 and CLK4 start alternating between VDD and ground. As a result, sub-blocks 120-1, 120-2, . . . , 120-N of second branch 120 are enabled and driven by second enable signal EN2 and inverted clock signal CLKB, and thus a pumping process of second branch 120 starts. Specifically, the odd-numbered sub-blocks 120-1, 120-3, . . . , and even-numbered sub-blocks 120-2, 120-4, . . . , are respectively driven by third clock signal CLK3 and fourth clock signal CLK4 in alternate time intervals. Therefore, each sub-block is charged by the charge in its previous sub-block. As a result, output voltage Vout2 at output end 124 of second branch 120 is pumped until it reaches N×VDD, where N is the number of sub-blocks in second branch 120. Because output voltage Vout at output node 150 has already reached N×VDD at time t1, output voltage Vout does not change after time t1 regardless of the value of output voltage Vout2.

During the pumping process of each one of first branch 110 and second branch 120, the current that flows in first branch 110 or second branch 120 reaches a peak (hereinafter referred to as “peak current”) at a certain time and then gradually decreases towards the end of the pumping process. If the pumping processes of first and second branches 110 and 120 start at the same time, then the peak current of first branch 110 will overlap with the peak current of second branch 120 such that circuit 100 will conduct a maximal peak current which is twice as much as the peak current flowing in each one of first and second branches 110 and 120. However, in the embodiment illustrated in FIG. 3, the pumping processes of first branch 110 and second branch 120 are configured to start at different times t0 and t2. Specifically, the sub-blocks of second branch 120 are enabled at time t2 after the pumping process of the sub-blocks of first branch 110 is completed at time t1. Therefore, the current that flows in circuit 100 will not reach the maximal peak current generated when the sub-blocks of first and second branches 110 and 120 are enabled at the same time.

Although in the embodiment illustrated in FIG. 3, the sub-blocks of second branch 120 are enabled at time t2 after the pumping process of the sub-blocks of first branch 110 is completed at time t1, the present disclosure is not so limited. That is, the sub-blocks of second branch 120 can be enabled any time after the sub-blocks of first branch 110 are enabled. In some embodiments, the sub-blocks of second branch 120 are enabled before the pumping process of the sub-blocks of first branch 110 is completed.

Although circuit 100 illustrated in FIG. 1 includes two branches 110 and 120, the present disclosure is not so limited. That is, circuit 100 can include more than two branches. When circuit 100 includes more than two branches, the sub-blocks of different branches are enabled at different times. For example, if circuit 100 includes first through fourth branches, then the sub-blocks of the first branch are enabled at a first time, the sub-blocks of the second branch are enabled at a second time, the sub-blocks of the third branch are enabled at a third time, the sub-blocks of the fourth branch are enabled at a fourth time, with the first through fourth times being different from each other.

Although each one of first and second branches 110 and 120 of circuit 100 illustrated in FIG. 1 includes N sub-blocks, where N is an even number, the present disclosure is not so limited. That is, N can be an odd number.

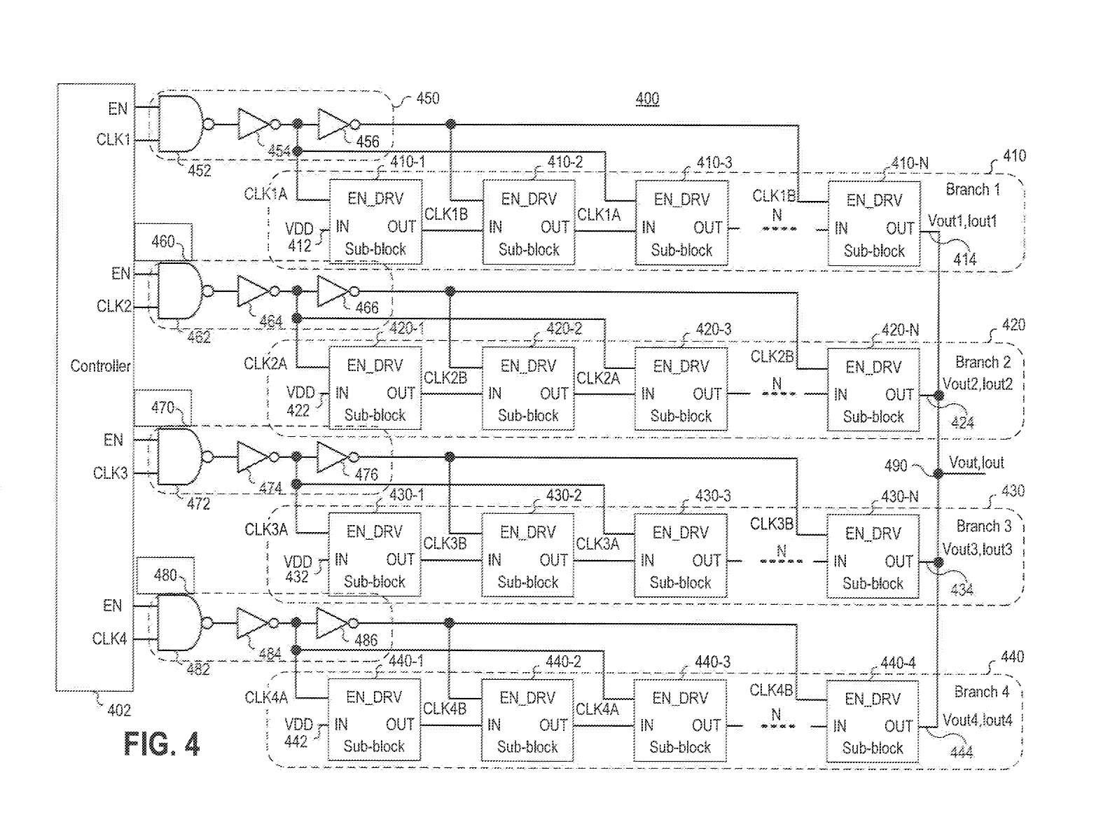

FIG. 4 schematically illustrates a charge pump circuit 400 (hereinafter referred to as “circuit 400”), according to an illustrated embodiment. Circuit 400 includes first through fourth branches 410, 420, 430, and 440 coupled in parallel, and first through fourth clock transfer circuits 450, 460, 470, and 480 respectively coupled to first through fourth branches 410, 420, 430, and 440.

First branch 410 includes an input end 412 for receiving a first supply voltage VDD, an output end 414 for outputting a first output voltage Vout1 and a first output current Iout1, and N sub-blocks 410-1, 410-2, . . . , 410-N coupled in series between input end 412 and output end 414. As illustrated in FIG. 4, N is an even number. However, in other embodiments of the disclosure, N can be an odd number. Sub-blocks 410-1, 410-2, . . . , 410-N have the same structure. Each one of sub-blocks 410-1, 410-2, . . . , 410-N includes a unit pump circuit, such as unit pump circuit 200 illustrated in FIG. 2. Each one of sub-blocks 410-1, 410-2, . . . , 410-N includes a driver enable terminal EN_DRV, an input terminal IN, and an output terminal OUT. Input terminal IN of the first sub-block 410-1, which constitutes input end 412 of first branch 410, is coupled to receive the first supply voltage VDD. Output terminal OUT of each of sub-blocks 410-1, 410-2, . . . , 410-N−1 is coupled to the input terminal IN of the next sub-block. Output terminal OUT of the last sub-block 410-N, which constitutes output end 414 of first branch 410, is coupled to output the first output voltage Vout1 and the first output current Iout1 to an external load (not illustrated). Driver enable terminals EN_DRV of sub-blocks 410-1, 410-2, . . . , 410-N are coupled to clock transfer circuit 450 to receive clock signals.

First clock transfer circuit 450 includes a NAND gate 452, a first inverter 454, and a second inverter 456 coupled in series. First clock transfer circuit 450 receives a common enable signal EN and a first clock signal CLK1 from a controller 402, and generates and selectively applies clock signals CLK1A and CLK1B to sub-blocks 410-1, 410-2, . . . , 410-N of first branch 410. Specifically, NAND gate 452 includes a first input terminal coupled to receive common enable signal EN, a second input terminal coupled to receive first clock signal CLK1, and an output terminal coupled to an input terminal of first inverter 454. First inverter 454 includes the input terminal coupled to the output terminal of NAND gate 452, and an output terminal coupled to an input terminal of second inverter 456 and the driver enable terminals EN_DRV of odd-numbered sub-blocks 410-1, 410-3, . . . , to provide clock signal CLK1A. Second inverter 456 includes the input terminal coupled to the output terminal of first inverter 454, and an output terminal coupled to the driver enable terminals EN_DRV of even-numbered sub-blocks 410-2, 410-4, . . . , to provide clock signal CLK1B.

First clock signal CLK1 alternates between the first supply voltage VDD and the second supply voltage Vss (e.g., ground). When the common enable signal EN is at a high level, clock signal CLK1A output from first inverter 454 has the same phase and amplitude as first clock signal CLK1, and clock signal CLK1B output from second inverter 456 is an inversion of first clock signal CLK1.

Second branch 420 includes an input end 422 for receiving the first supply voltage VDD, an output end 424 for outputting a second output voltage Vout2 and a second output current Iout2, and N sub-blocks 420-1, 420-2, . . . , 420-N coupled in series between input end 422 and output end 424. Third branch 430 includes an input end 432 for receiving the first supply voltage VDD, an output end 434 for outputting a third output voltage Vout3 and a third output current Iout3, and N sub-blocks 430-1, 430-2, . . . , 430-N coupled in series between input end 432 and output end 434. Fourth branch 440 includes an input end 442 for receiving the first supply voltage VDD, an output end 444 for outputting a fourth output voltage Vout4 and a fourth output current Iout4, and N sub-blocks 440-1, 440-2, . . . , 440-N coupled in series between input end 442 and output end 444. The structures and the connection of the sub-blocks of second, third, and fourth branches 420, 430, and 440 are similar to those of the sub-blocks of first branch 410. Therefore, a detailed description is not provided.

Output ends 414, 424, 434, and 444 of first through fourth branches 410, 420, 430, and 440 are respectively coupled to an output node 490 of circuit 400. Because first through fourth branches 410, 420, 430, and 440 include the same number of sub-blocks, Vout1, Vout2, Vout3, and Vout4 have the same magnitude. Thus, circuit 400 provides an output voltage Vout which has the same magnitude as Vout1, Vout2, Vout3, and Vout4, and an output current Iout which is the sum of Iout1, Iout2, Iout3, and Iout4.

Second clock transfer circuit 460 includes a NAND gate 462, a first inverter 464, and a second inverter 466 coupled in series, to receive the common enable signal EN and a second clock signal CLK2 from controller 402, and to generate and selectively apply clock signals CLK2A and CLK2B to sub-blocks 420-1, 420-2, . . . , 420-N of second branch 420. Third clock transfer circuit 470 includes a NAND gate 472, a first inverter 474, and a second inverter 476 coupled in series, to receive the common enable signal EN and a third clock signal CLK3 from controller 402, and to generate and selectively apply clock signals CLK3A and CLK3B to sub-blocks 430-1, 430-2, . . . , 430-N of third branch 430. Fourth clock transfer circuit 480 includes a NAND gate 482, a first inverter 484, and a second inverter 486 coupled in series, to receive the common enable signal EN and a fourth clock signal CLK4 from controller 402, and to generate and selectively apply clock signals CLK4A and CLK4B to sub-blocks 440-1, 440-2, . . . , 440-N of fourth branch 440. The structures and the connections of second, third, and fourth clock transfer circuits 460, 470, and 480 are similar to those of first clock transfer circuit 460. Therefore, a detailed description is not provided.

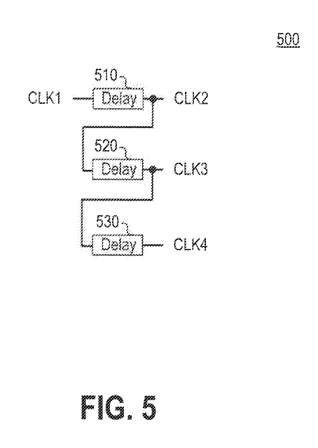

FIG. 5 schematically illustrates a circuit 500 for generating the second, third, and fourth clock signals CLK2, CLK3, and CLK4 of FIG. 4, according to an illustrated embodiment. Circuit 500 can be included in controller 402 illustrated in FIG. 4. As illustrated in FIG. 5, circuit 500 includes a first delay circuit 510, a second delay circuit 520, and a third delay circuit 530. First delay circuit 510 includes an input terminal coupled to receive first clock signal CLK1, and an output terminal coupled to output second clock signal CLK2. Second delay circuit 520 includes an input terminal coupled to the output terminal of first delay circuit 510 to receive second clock signal CLK2, and an output terminal coupled to output third clock signal CLK3. Third delay circuit 530 includes an input terminal coupled to the output terminal of second delay circuit 520 to receive third clock signal CLK3, and an output terminal coupled to output fourth clock signal CLK4.

First, second, and third delay circuit 510, 520, and 530 have the same structure, and each generates a delay time. As a result, the second, third, and fourth clock signals CLK2, CLK3, and CLK4 are sequentially delayed by the delay time generated by first, second, and third delay circuit 510, 520, and 530, respectively. Specifically, second clock signal CLK2 is delayed relative to first clock signal CLK1 by the delay time, third clock signal CLK3 is delayed relative to second clock signal CLK2 by the delay time, and fourth clock signal CLK4 is delayed relative to third clock signal CLK3 by the delay time.

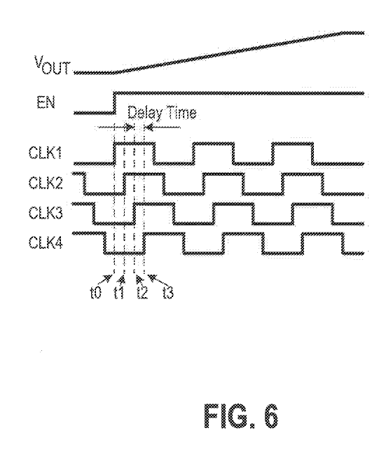

FIG. 6 schematically illustrates waveforms of signals for controlling circuit 400 of FIG. 4, according to an illustrated embodiment. The waveform of Vout at output node 490 of circuit 400 is also illustrated.

Before time t0, common enable signal EN is at a low level (e.g., ground). As a result, clock signals CLK1A, CLK2A, CLK3A, and CLK4A do not alternate and remain as the second supply voltage Vss (e.g., ground). Similarly, clock signals CLK1B, CLK2B, CLK3B, and CLK4B do not alternate and remain as the first supply voltage VDD. Thus, no alternating clock signal is applied to the sub-blocks of first through fourth branches 410 through 440. Consequently, none of first through fourth branches 410 through 440 is enabled, and thus output voltage Vout at output node 490 of circuit 100 is at a low level (e.g., 0V).

At time t0, common driver enable signal EN transitions from the low level to a high level. At the same time, first clock signal CLK1 rises to the first supply voltage VDD. As a result, clock signals CLK1A and CLK1B applied to sub-blocks 410-1, 410-2, . . . , 410-N of first branch 410 start alternating between VDD and ground. Consequently, sub-blocks 410-1, 410-2, . . . , 410-N of first branch 410 are enabled and driven by first clock signal CLK1, and thus a pumping process of first branch 410 starts. Consequently, first output voltage Vout1 at output end 414 of first branch 410 is pumped and starts rising until it reaches N×VDD, where N is the number of sub-blocks in first branch 410.

At time t1, second clock signal CLK2 rises to the first supply voltage VDD. The interval between time t1 and time t0 is the delay time generated by first delay circuit 510. As a result, clock signals CLK2A and CLK2B start alternating between VDD and ground. Consequently, sub-blocks 420-1, 420-2, . . . , 420-N of second branch 420 are enabled and driven by second clock signal CLK2, and thus a pumping process of second branch 420 starts. Consequently, second output voltage Vout2 at output end 424 of second branch 420 is pumped and starts rising until it reaches N×VDD, where N is the number of sub-blocks in second branch 420.

At time t2, third clock signal CLK3 rises to the first supply voltage VDD. The interval between time t2 and time t1 is the delay time generated by second delay circuit 520. As a result, clock signals CLK3A and CLK3B start alternating between VDD and ground. Consequently, sub-blocks 430-1, 430-2, . . . , 430-N of third branch 430 are enabled and driven by third clock signal CLK3, and thus a pumping process of third branch 430 starts. Consequently, third output voltage Vout3 at output end 434 of third branch 430 is pumped and starts rising until it reaches N×VDD, where N is the number of sub-blocks in third branch 430.

At time t3, fourth clock signal CLK4 rises to the first supply voltage VDD. The interval between time t3 and time t2 is the delay time generated by third delay circuit 530. As a result, clock signals CLK4A and CLK4B start alternating between VDD and ground. Consequently, sub-blocks 440-1, 440-2, . . . , 440-N of fourth branch 440 are enabled and driven by fourth clock signal CLK4, and thus a pumping process of fourth branch 440 starts. Consequently, fourth output voltage Vout4 at output end 444 of fourth branch 440 is pumped and starts rising until it reaches N×VDD, where N is the number of sub-blocks in fourth branch 440.

During the pumping processes of first through fourth branches 410 through 440, the current that flows in each one of first through fourth branches 410 through 440 reaches a peak, i.e., a peak current, at a certain time. If the pumping processes of first through fourth branches 410 through 440 start at the same time, i.e., if the sub-blocks of first through fourth branches 410 through 440 are enabled at the same time and driven by the same clock signal, then the peak currents of first through fourth branches 410 through 440 will overlap with each other such that circuit 400 will conduct a maximal peak current which is the sum of the peak currents in first through fourth branches 410 through 440. However, in the embodiment illustrated in FIG. 6, the clock signals CLK1 through CLK4 applied to first through fourth branches 410 through 440 rise and fall at different times, and thus the pumping processes of first through fourth branches 410 through 440 start at different times. That is, the sub-blocks of first through fourth branches 410 through 440 are enabled and driven by clock signals CLK1 through CLK4 at different times. As a result, the current that flows in circuit 400 is lower than the maximal peak current generated when the sub-blocks of first through fourth branches 410 through 440 are enabled at the same time and driven by the same clock signal.

The delay time generated by each of delay circuits 510, 520, and 530 can be varied according to the actual application of circuit 400. In some embodiments, the delay time can be equal to P/(2×M), where P is the period of the clock signal CLK1, and M is the number of branches in circuit 400. In the embodiment illustrated in FIGS. 4-6, M=4.

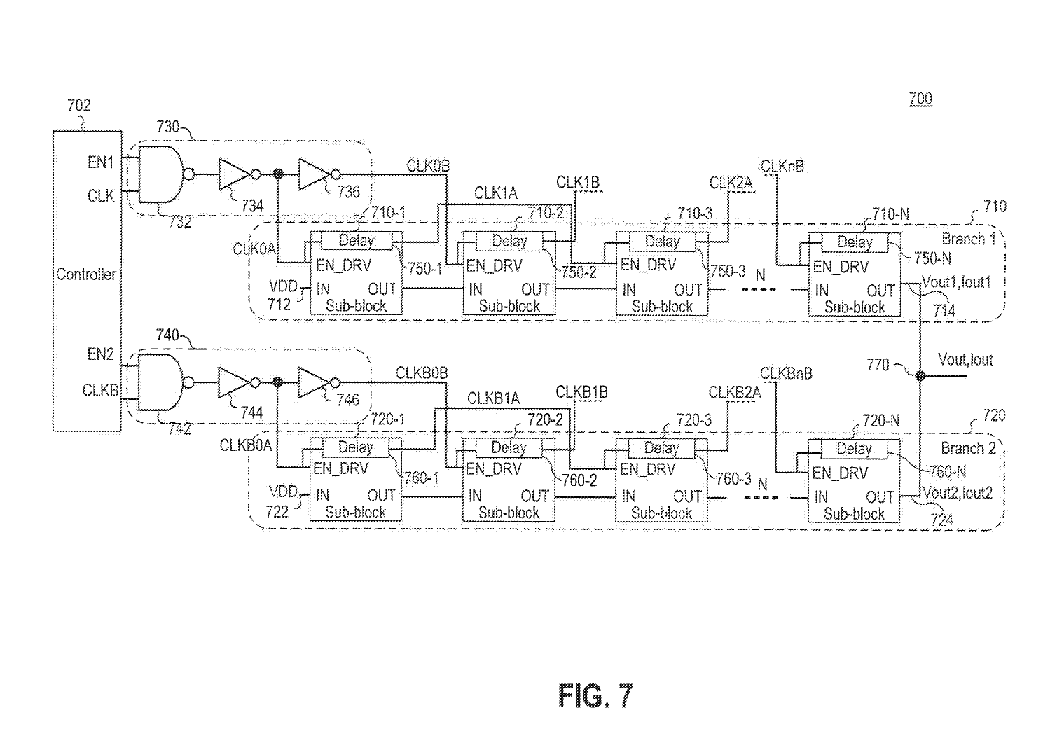

FIG. 7 schematically illustrates a charge pump circuit 700 (hereinafter referred to as “circuit 700”), according to an illustrated embodiment. Circuit 700 includes a first branch 710 and a second branch 720 coupled in parallel, and a first clock transfer circuit 730 and a second clock transfer circuit 740 respectively coupled to first branch 710 and second branch 720.

First branch 710 includes an input end 712 for receiving a first supply voltage VDD, an output end 714 for outputting a first output voltage Vout1 and a first output current Iout1, and N sub-blocks 710-1, 710-2, . . . , 710-N coupled in series between input end 712 and output end 714. Sub-blocks 710-1, 710-2, . . . , 710-N have the same structure. Each one of sub-blocks 710-1, 710-2, . . . , 710-N includes a unit pump circuit such as unit pump circuit 200 illustrated in FIG. 2, a delay circuit 750-1, 750-2, . . . , 750-N, respectively, a driver enable terminal EN_DRV, an input terminal IN, and an output terminal OUT. Input terminal IN of the first sub-block 710-1, which constitutes input end 712 of first branch 710, is coupled to receive the first supply voltage VDD. Output terminal OUT of each of sub-blocks 710-1, 710-2, . . . , 710-N−1 is coupled to the input terminal IN of the next sub-block. Output terminal OUT of the last sub-block 710-N, which constitutes output end 714 of first branch 710, is coupled to output the first output voltage Vout1 and the first output current Iout1 to an external load (not illustrated).

Each delay circuit 750-1, 750-2, . . . , 750-N, includes an input terminal for receiving a clock signal and an output terminal for outputting a delayed clock signal which is delayed by a delay time. The input terminal of delay circuit 750-1 and driver enable terminal EN_DRV of first sub-block 710-1 are coupled to clock transfer circuit 730 to receive a clock signal CLK0A. The output terminal of delay circuit 750-1, 750-3, . . . , of each odd-numbered sub-block 710-1, 710-3, . . . , is coupled to the input terminal of delay circuit 750-3, 750-5, . . . , and driver enable terminal EN_DRV of the next odd-numbered sub-block 710-3, 710-5, . . . . For example, delay circuit 750-1 of first sub-block 710-1 receives clock signal CLK0A and outputs a delayed clock signal CLK1A to the input terminal of delay circuit 750-3 and driver enable terminal EN_DRV of sub-block 710-3; delay circuit 750-3 of sub-block 710-3 outputs a delayed clock signal CLK2A to the input terminal of delay circuit 750-5 and driver enable terminal EN_DRV of sub-block 710-5 (not shown in FIG. 7); and so on. As a result, clock signals CLK1A, CLK2A, . . . , CLKnA are sequentially delayed by the delay time generated by delay circuits 750-1, 750-3, . . . , 750-N−1, respectively, where N is an even number and represents the number of sub-blocks in first branch 710, and n=N/2.

Similarly, the output terminal of delay circuit 750-2, 750-4, . . . , of each even-numbered sub-block 710-2, 710-4, . . . , is coupled to the input terminal of delay circuit 750-4, 750-6, . . . , and driver enable terminal EN_DRV of the next even-numbered sub-block 710-4, 710-6, . . . . For example, delay circuit 750-2 of sub-block 710-2 receives a clock signal CLK0B and outputs a delayed clock signal CLK1B to the input terminal of delay circuit 750-4 and driver enable terminal EN_DRV of sub-block 710-4 (not shown in FIG. 7); delay circuit 750-4 of sub-block 710-4 outputs a delayed clock signal CLK2B to the input terminal of delay circuit 750-6 and driver enable terminal EN_DRV of sub-block 710-6 (not shown in FIG. 7); and so on. As a result, clock signals CLK1B, CLK2B, . . . , CLKnB are sequentially delayed by the delay time generated by delay circuits 750-2, 750-4, . . . , 750-N, respectively, where N is an even number and represents the number of sub-blocks in first branch 710, and n=N/2.

First clock transfer circuit 730 includes a NAND gate 732, a first inverter 734, and a second inverter 736 coupled in series. First clock transfer circuit 730 receives a common driver enable signal EN and a common clock signal CLK from a controller 702, and applies clock signals CLK0A and CLK0B to sub-blocks 710-1 and 710-2, respectively. Specifically, NAND gate 732 includes a first input terminal coupled to receive common driver enable signal EN, a second input terminal coupled to receive common clock signal CLK, and an output terminal coupled to an input terminal of first inverter 734. First inverter 734 includes the input terminal coupled to the output terminal of NAND gate 732, and an output terminal coupled to an input terminal of second inverter 736 and driver enable terminal EN_DRV of sub-block 710-1 to provide clock signal CLK0A. Second inverter 736 includes the input terminal coupled to the output terminal of first inverter 734, and an output terminal coupled to driver enable terminal EN_DRV of sub-block 710-2 to provide clock signal CLK0B.

Common clock signal CLK alternates between the first supply voltage VDD and the second supply voltage Vss (e.g., ground). When the common driver enable signal EN is at a high level, clock signal CLK0A output from first inverter 734 has the same phase and amplitude as common clock signal CLK, and clock signal CLK0B output from second inverter 736 is an inversion of common clock signal CLK and an inversion of clock signal CLK0A.

Second branch 720 includes an input end 722 for receiving first supply voltage VDD, an output end 724 for outputting a second output voltage Vout2 and a second output current Iout2, and N sub-blocks 720-1, 720-2, . . . , 720-N coupled in series between input end 722 and output end 724. Sub-blocks 720-1, 720-2, . . . , 720-N have the same structure. Each one of sub-blocks 720-1, 720-2, . . . , 720-N includes a unit pump circuit such as unit pump circuit 200 illustrated in FIG. 2, a delay circuit 760-1, 760-2, . . . , 760-N, respectively, a driver enable terminal EN_DRV, an input terminal IN, and an output terminal OUT. The structures and the connections of the sub-blocks of second branch 720 are similar to those of the sub-blocks of first branch 710. Therefore, a detailed description is not provided.

Second clock transfer circuit 740 includes a NAND gate 742, a first inverter 744, and a second inverter 746 coupled in series. Second clock transfer circuit 730 receives a common driver enable signal EN and a common clock signal CLKB from controller 702, which is an inversion of clock signal CLK, and generates and applies clock signals CLKB0A and CLKB0B to sub-blocks 720-1 and 720-2, respectively. The structures and the connections of second clock transfer circuit 740 are similar to those of first clock transfer circuit 730. Therefore, a detailed description is not provided.

Common clock signal CLKB alternates between the first supply voltage VDD and the second supply voltage Vss (e.g., ground). When the common driver enable signal EN is at a high level, clock signal CLKB0A output from first inverter 744 has the same phase and amplitude as common clock signal CLKB, and clock signal CLKB0B output from second inverter 736 is an inversion of common clock signal CLK and an inversion of clock signal CLKB0A. Clock signals CLKB1A, CLKB2A, . . . , CLKBnA are sequentially delayed by the delay time generated by delay circuits 760-1, 760-3, . . . , 760-N−1, respectively, where N is an even number and represents the number of sub-blocks in second branch 720, and n=N/2. Clock signals CLKB1B, CLKB2B, . . . , CLKBnB are sequentially delayed by the delay time generated by delay circuits 760-2, 760-4, . . . , 760-N, respectively, where N is an even number and represents the number of sub-blocks in second branch 720, and n=N/2.

Output ends 714 and 724 of first and second branches 710 and 720 are respectively coupled to an output node 770 of circuit 700. Because first and second branches 710 and 720 include the same number of sub-blocks, Vout1 and Vout2 have the same magnitude. Thus, circuit 700 provides an output voltage Vout which has the same magnitude as Vout1 and Vout2, and an output current Iout which is the sum of Iout1 and Iout2.

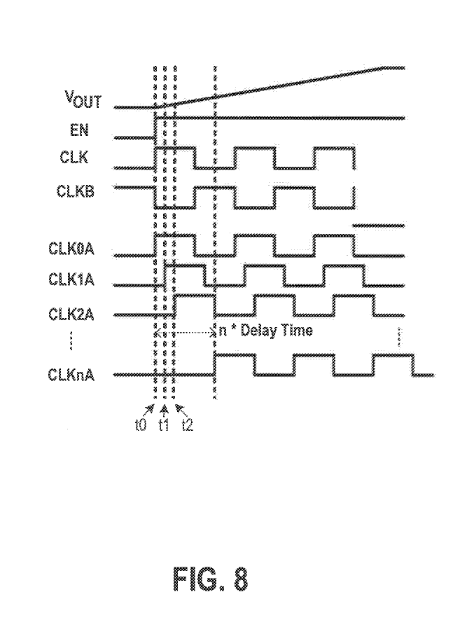

FIG. 8 schematically illustrates waveforms of signals for controlling circuit 700 of FIG. 7, according to an illustrated embodiment. The waveform of Vout at output node 770 of circuit 700 is also illustrated.

Before time t0, common enable signal EN is at a low level (e.g., ground). As a result, clock signals CLK0A, CLK1A, . . . , CLKnA, CLK0B, CLK1B, . . . , CLKnB, CLKB0A, CLKB1A, . . . , CLKBnA, CLKB0B, CLKB1B, . . . , CLKBnB do not alternate. Thus, no alternating clock signal is applied to the sub-blocks of first and second branches 710 through 720. Consequently, neither one of first and second branches 710 and 720 is enabled, and thus output voltage Vout at output node 770 of circuit 700 is at a low level (e.g., 0V).

At time t0, common driver enable signal EN transitions from the low level to a high level. At the same time, common clock signal CLK rises to the first supply voltage VDD. As a result, clock signal CLK0A starts alternating between VDD and ground, and thus sub-block 710-1 is enabled and driven by clock signal CLK0A. Similarly, clock signals CLK0B, CLKB0A, and CLKB0B (not illustrated) start alternating between VDD and ground, and thus sub-blocks 710-2, 720-1, 720-2 are enabled and driven by clock signals CLK0B, CLKB0A, and CLKB0B, respectively.

At time t1, clock signal CLK1A rises to the first supply voltage VDD. The interval between time t1 and time t0 is the delay time generated by delay circuit 750-1. As a result, clock signal CLK1A starts alternating between VDD and ground, and thus sub-block 710-3 is enabled and driven by clock signal CLK1A. Similarly, clock signals CLK1B, CLKB1A, and CLKB1B (not illustrated) start alternating between VDD and ground, and thus sub-blocks 710-4, 720-3, 720-4 are enabled and driven by clock signals CLK1B, CLKB1A, and CLKB1B, respectively.

At time t2, clock signal CLK2A rises to the first supply voltage VDD. The interval between time t2 and time t1 is the delay time generated by delay circuit 750-3. As a result, clock signal CLK2A starts alternating between VDD and ground, and thus sub-block 710-5 is enabled and driven by clock signal CLK2A. Similarly, clock signals CLK2B, CLKB2A, and CLKB2B (not illustrated) start alternating between VDD and ground, and thus sub-blocks 710-6, 720-5, 720-6 are enabled and driven by clock signals CLK2B, CLKB2A, and CLKB2B, respectively.

Subsequently, odd-numbered sub-blocks 710-7, 710-9, . . . , 710-N−1 are sequentially enabled and driven by clock signals CLK3A, CLK4A, . . . . , CLKnA; even-numbered sub-blocks 710-8, 710-10, . . . , 710-N are sequentially enabled and driven by clock signals CLK3B, CLK4B, . . . , CLKnB; odd-numbered sub-blocks 720-7, 720-9, . . . , 720-N−1 are sequentially enabled and driven by clock signals CLKB3A, CLKB4A, . . . , CLKBnA; and even-numbered sub-blocks 720-8, 720-10, . . . , 720-N are sequentially enabled and driven by clock signals CLKB3B, CLKB4B, . . . , CLKBnB.

During the pumping processes of first and second branches 710 and 720, the current that flows in each one of first and second branches 710 and 720 reaches a peak, i.e., a peak current. If the sub-blocks of first and second branches 710 and 720 are enabled at the same time and driven by the same clock signal, then circuit 700 will conduct a maximal peak current which is the sum of the peak currents of first and second branches 710 and 720. However, in the embodiment illustrated in FIG. 8, the sub-blocks of each one of first and second branches 710 and 720 are sequentially enabled. As a result, the peak current that flows in each one of first and second branches 710 and 720 is lower than a peak current generated when the sub-blocks of each one of first and second branches 710 and 720 are enabled at the same time. Consequently, the current that flows in circuit 700 is lower than the maximal peak current generated when the sub-blocks of first and second branches 710 and 720 are enabled at the same time and driven by the same clock signal.

The delay time generated by each of delay circuits 750-1, 750-2, . . . , 750-N, 760-1, 760-2, . . . , 760-N, can be varied according to the actual application of circuit 700. In some embodiments, the delay time can be equal to P/(2×n), where P is the period of the clock signal CLK, and n=N/2, where N is an even number and represents the number of sub-blocks in each branch in circuit 700.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A charge pump circuit, comprising:
a plurality of branches coupled in parallel, each branch including a plurality of sub-blocks coupled in series, and each sub-block including a unit pump circuit; and
a plurality of clock transfer circuits coupled to corresponding ones of the plurality of branches for providing clock signals to the corresponding branches,
wherein the sub-blocks of different branches are enabled and driven by the clock signals at different times.

2. The charge pump circuit of claim 1, wherein each clock transfer circuit receives a respective enable signal and a clock signal, and provides a first clock signal to odd-numbered sub-blocks in the corresponding branch, and a second clock signal to even-numbered sub-blocks in the corresponding branch.

3. The charge pump circuit of claim 2, wherein the enable signals received by different clock transfer circuits transition from a low level to a high level at different times.

4. The charge pump circuit of claim 3, wherein the plurality of branches include a first branch and a second branch, and the plurality of clock transfer circuits include a first clock transfer circuit and a second clock transfer circuit respectively coupled to the first branch and the second branch,
the enable signal received by the second clock transfer circuit transitions from the low level to the high level after a pumping process of the first branch is completed.

5. The charge pump circuit of claim 1, wherein each clock transfer circuit receives a common enable signal and a respective clock signal, and provides a first clock signal to odd-numbered sub-blocks in the corresponding branch, and a second clock signal to even-numbered sub-blocks in the corresponding branch.

6. The charge pump circuit of claim 5, wherein the clock signals received by different clock transfer circuits transition from a low level to a high level at different times.

7. The charge pump circuit of claim 6, further including a plurality of delay circuits for sequentially delaying the clock signals.

8. A charge pump circuit, comprising:
a plurality of branches coupled in parallel, each branch including a plurality of sub-blocks coupled in series, and each sub-block including a unit pump circuit and a delay circuit;
a plurality of clock transfer circuits coupled to corresponding ones of the plurality of branches for providing clock signals to the corresponding branches,
wherein the sub-blocks of each branch are sequentially enabled and driven by the clock signals.

9. The charge pump circuit of claim 8, wherein each clock transfer circuit receives a common enable signal and a clock signal, and provides a first clock signal to a first sub-block in the corresponding branch, and a second clock signal to a second sub-block in the corresponding branch.

10. The charge pump circuit of claim 9, wherein
the delay circuit of each odd-numbered sub-block after the first sub-block receives a clock signal from a previous odd-numbered sub-block and provides a delayed clock signal to the next odd-numbered sub-block, and
the delay circuit of each even-numbered sub-block after the second sub-block receives a clock signal from a previous even-numbered sub-block and provides a delayed clock signal to the next even-numbered sub-block.

11. A method for controlling a charge pump circuit, comprising:
providing the charge pump circuit including a plurality of branches coupled in parallel, each branch including a plurality of sub-blocks coupled in series; and
enabling and driving the sub-blocks of different branches at different times.

12. The method of claim 11, wherein providing the charge pump circuit further includes coupling a plurality of clock transfer circuits to corresponding ones of the plurality of branches.

13. The method of claim 12, wherein enabling and driving the sub-blocks of different branches at different times further includes:
providing a respective enable signal and a clock signal to each clock transfer circuit; and
providing, by each clock transfer circuit, a first clock signal to odd-numbered sub-blocks in the corresponding branch, and a second clock signal to even-numbered sub-blocks in the corresponding branch.

14. The method of claim 13, further including transitioning the enable signals provided to different clock transfer circuits from a low level to a high level at different times.

15. The method of claim 12, wherein enabling and driving the sub-blocks of different branches at different times further includes:
providing a common enable signal and a respective clock signal to each clock transfer circuit;
providing, by each clock transfer circuit, a first clock signal to odd-numbered sub-blocks in the corresponding branch, and a second clock signal to even-numbered sub-blocks in the corresponding branch.

16. The method of claim 15, further including sequentially delaying the clock signals provided to different clock transfer circuits.

17. A method for controlling a charge pump circuit, comprising:
providing the charge pump circuit including a plurality of branches coupled in parallel, each branch including a plurality of sub-blocks coupled in series; and
sequentially enabling and driving the sub-blocks of each branch.

18. The method of claim 17, wherein providing the charge pump circuit further includes coupling a plurality of clock transfer circuits to corresponding ones of the plurality of branches.

19. The method of claim 18, wherein sequentially enabling and driving the sub-blocks of each branches includes:
providing a common enable signal and a clock signal to each clock transfer circuit; and
providing, by each clock transfer circuit, a first clock signal to a first sub-block in the corresponding branch, and a second clock signal to a second sub-block in the corresponding branch.

20. The method of claim 19, further including providing a delay circuit in each sub-block,
wherein the delay circuit of each odd-numbered sub-block after the first sub-block receives a clock signal from a previous odd-numbered sub-block and provides a delayed clock signal to the next odd-numbered sub-block, and
the delay circuit of each even-numbered sub-block after the second sub-block receives a clock signal from a previous even-numbered sub-block and provides a delayed clock signal to the next even-numbered sub-block.
